(19) United States
(12) Patent Application Publication
(10) Pub. No.: US 2015/0019324 A1
(43) Pub. Date: Jan. 15, 2015

(54) SYSTEM AND METHOD FOR CENTRALIZED ADVERTISEMENTS SERVING AND VERIFICATION

(71) Applicant: Sizmek Technologies Ltd., Herzeliya Pituach (IL)

(72) Inventor: Jonathan Schler, Petach Tikwa (IL)

(73) Assignee: SIZMEK TECHNOLOGIES LTD., Herzeliya Pituach (IL)

(21) Appl. No.: 14/504,589

(22) Filed: Oct. 2, 2014

Related U.S. Application Data
(63) Continuation-in-part of application No. 14/168,779, filed on Jan. 30, 2014.
Application No. 14/168,779 is a continuation-in-part of application No. 13/221,623, filed on Aug. 30, 2011.

(51) Int. Cl. G06Q 30/02

(52) U.S. Cl. CPC G06Q 30/0242; G06Q 30/0205
USPC 705/14.41

(57) ABSTRACT

A method and system for centralized serving and verification of an advertising campaign are provided. The method includes generating a script based on at least verification parameters for the advertising campaign; generating a single tag programmed to initiate both serving and verification of an advertisement of the advertising campaign, wherein an instance of the single tag is embedded in each webpage selected to display an advertisement of the advertising campaign; upon reception of a call from a webpage selected to display an advertisement, selecting an advertisement to be placed in the webpage; and inserting a script to the advertisement, wherein the script causing the placement and verification of the advertisement in the web page, wherein the call is triggered by the instance of the single tag.

### CROSS-REFERENCE TO RELATED APPLICATIONS

This application is a continuation-in-part application of U.S. patent application Ser. No. 14/168,779, now pending, filed on Jan. 30, 2014, which is a continuation-in-part application of U.S. patent application Ser. No. 13/221,623 filed on Aug. 30, 2011, now pending, the contents of which are herein incorporated by reference for all that they contain.

### TECHNICAL FIELD

The present invention relates generally to online advertising, and more particularly to demographic profiling of users for advertising verification.

### BACKGROUND

Websites, including commercial, corporate and personal websites, publish advertisements on their web pages. Such advertisements are typically published in the form of banners that may be comprised of static or rich media content. Banners that include rich media content are displayed as a combination of text, audio, still images, animation, video, and interactivity content for forms.

Advertisement (Ad) serving relates to the placements of advertisements on web pages and/or multimedia content. In addition to placing of advertisements, advertisement serving systems also select which advertisements should be served to websites based on advertising campaign preferences, count impressions, count clicks on advertisements, and monitored progress of different advertising campaigns. An advertisement serving system is typically realized as a server backed by a database server that stores advertisements.

FIG. 1 shows an exemplary and non-limiting schematic diagram of a computer system 100 illustrating a typical advertisement serving process. User devices 120-1 through 120-N (hereinafter referred to collectively as user devices 120 and individually as a user device 120), an advertisement-serving (ad-serving) system 130, web servers 140-1 through 140-M (hereinafter referred to collectively as web servers 140 or individually as a web server 140), and a verification server 160 are communicatively connected to a network 110. The network 100 is typically the World Wide Web (WWW). The web servers 140-1 through 140-M are often referred to as publishers. A user device 120 may be, but is not limited to, a personal computer (PC), a personal digital assistant (PDA), a mobile phone, a smart phone, a tablet computer, a laptop, and the like, having capabilities for downloading and displaying webpages.

The web servers 140-1 through 140-M host websites accessible through the user devices 120-1 through 120-M. The webpages provided by the web servers 140 may include advertisements served by the ad-serving system 130. In a typical deployment, a webpage downloaded from a web server 140 includes a piece of code that calls for the ad-serving system 130 to place an advertisement in the webpage.

The ad-serving system 130 upon receiving a call from the web-server 140 selects the advertisement to be served based on serving parameters that correlate to campaign preferences set by an advertisement agency 180. Typically, an ad-serving system handles multiple campaigns, and each campaign may include multiple advertisements to be served at different webpages. As such, the campaign preferences should capture all sets of provisions to allow proper serving by the ad-serving system 130. Campaign preferences typically relate to the target demographics of the campaign and may include, but are not limited to, geographic locations of users of a webpage, certain subject matter (e.g., skateboards for demographics that are interesting in skateboarding), times of day of access by users of a webpage, and so on. For example, such provisions may include which webpages should be served with a set of advertisements. The serving parameters correlated to such provisions may include identification of such webpages by, e.g., their respective URLs. The webpages that will participate in the campaign may be selected based on a demographic that the campaign targets.

Other than serving advertisements, the advertising agency 180 is utilized to verify various facets of the campaign the campaign. Typically, the advertising agency 180 wishes to verify that the campaign reaches its target audience, which the number of impressions counted are actual advertisement views, that advertisements were not displayed along improper content, and so on.

Such verification is typically performed by the verification server 160, which monitors a campaign based on verification parameters defined by advertising agency 180. To properly monitor and verify the campaign, a verification tag (a piece of code) is inserted by a web server 140 in webpages on which a campaign runs. The verification tag calls for the verifications server 160 to run a script on the webpages that collects verification parameters. Such parameters are set by the verifications server 160.

Typically, the ad-serving and the verification processes are performed by two different companies that do not share an affiliation between them. Therefore, the serving and verification processes are usually performed in a distributed manner. This requires the advertising agency 180 to individually define the verification and serving parameters of the processes, and to further define how the processes can be performed on the different systems to allow proper serving and performance monitoring of the campaign. As a prime example, the verification parameters and process should be defined to monitor specific websites selected to display the advertisements' campaign which are defined by serving parameters. In addition, with respect to the requirement of defining these parameters properly, a campaign manager must typically work with at least two different companies that perform the advertisement serving and verification processes. This is a tedious and time consuming task that typically results in inefficient monitoring of advertisements.

It would therefore be advantageous to provide a solution that would overcome the deficiencies of the prior art with regard to online advertisement serving and verification.

### SUMMARY

Certain embodiments disclosed herein include a method for serving and verification of an advertising campaign. The method includes generating a script based on at least verification parameters for the advertising campaign; generating a single tag programmed to initiate both serving and verification of an advertisement of the advertising campaign, wherein an instance of the single tag is embedded in each webpage selected to display an advertisement of the advertising campaign; upon reception of a call from a webpage selected to display an advertisement, selecting an advertisement to be placed in the webpage; and inserting a script to the advertisement, wherein the script causing the placement and verification of the advertisement in the web page, wherein the call is triggered by the instance of the single tag.

Certain embodiments disclosed herein include further includes a system for performing verification of an advertising campaign. The system comprises a processor; and a memory coupled to the processor, containing a plurality of instructions that when executed by the processor configure the system to: generate a script based on at least verification parameters for the advertising campaign; generate a single tag programmed to initiate both serving and verification of an advertisement of the advertising campaign, wherein an instance of the single tag is embedded in each webpage selected to display an advertisement of the advertising campaign; upon reception of a call from a webpage selected to display an advertisement, select an advertisement to be placed in the webpage; and insert a script to the advertisement, wherein the script causing the placement and verification of the advertisement in the web page, wherein the call is triggered by the instance of the single tag.

Certain embodiments disclosed herein include further includes a method for centralized serving and verification of an advertising campaign. The method comprises generating a script based on at least verification parameters for the advertising campaign; generating a single tag programmed to initiate both serving and verification of an advertisement of the advertising campaign, wherein an instance of the single tag is embedded in each webpage selected to display an advertisement of the advertising campaign; upon reception of a call from a webpage selected to display an advertisement, selecting an advertisement to be placed in the webpage; inserting a script to the advertisement, wherein the script causing the placement and verification of the advertisement in the web page, wherein the call is triggered by the instance of the single tag; and performing a demographic verification for the advertising campaign in response to execution of the script on a plurality of webpages in which the advertisement is placed.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a diagram of a network system illustrating a conventional serving system.

FIG. 2 is a diagram of a network system for centralized serving and verification of advertisements.

FIG. 3 is a flow chart illustrating an operation of an ad-serving according to one embodiment.

FIG. 4 is a block diagram of a system for generating users' demographic profiles according to one embodiment.

FIG. 5 is a flowchart illustrating an online advertising verification method according to one embodiment.

FIG. 6 is a flowchart illustrating creation of a user's demographic profile according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

According to certain embodiments disclosed herein, serving and verification of online advertisements are performed in a centralized manner. The serving and verification are both activated by a single tag embedded in a web page. The single tag is created by the disclosed system, in part, based on serving and verification parameters defined by the advertising agency.

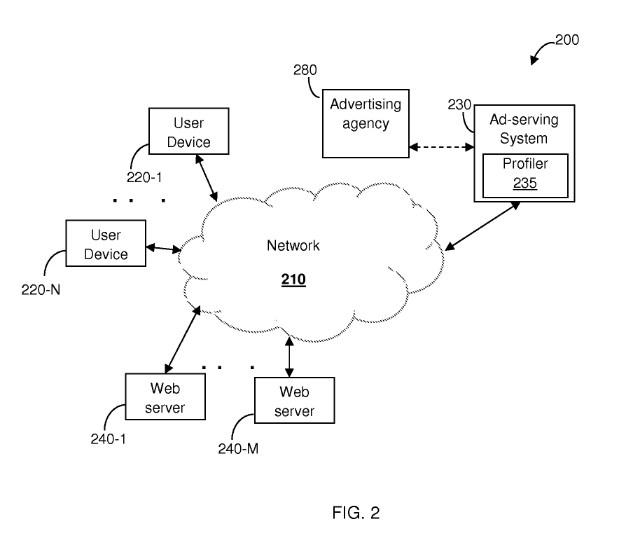

FIG. 2 shows an exemplary and non-limiting schematic diagram of a network system 200 utilized to describe the disclosed embodiments. The system 200 includes a network 210, which may be, but is not limited to, the Internet, the world-wide-web (WWW), a local area network (LAN), a wide area network (WAN), a metro area network (MAN), and the like.

As illustrated in FIG. 2, a plurality of user devices 220-1 through 220-N (hereinafter referred to collectively as user devices 220 and individually as a user device 220, merely for simplicity purposes), at least one ad-serving system 230, and a plurality of web servers 240-1 through 240-M (hereinafter referred to collectively as web servers 240 and individually as a web server 240, merely for simplicity purposes) are communicatively connected to the network 210. Each user device 220 may be, but is not limited to, a personal computer (PC), a personal digital assistant (PDA), a mobile phone, a smart phone, a tablet computer, a laptop, and the like, having capabilities for downloading and displaying webpages.

The web servers 240-1 through 240-M host websites accessible through the user devices 220-1 through 220-N. The webpages provided by the web servers 240 may include advertisements served by the ad-serving system 230. In a typical deployment, a webpage downloaded from a web server 240 includes a single tag that calls for the ad-serving system 230 to place an advertisement in the web page and verify the campaign goals for the ads. In an embodiment, the verification tag is a piece of code implemented, for example, as a JavaScript or HTML.

An exemplary and non-limiting tag that can be used to call the ad-serving system 230 is:

<script>
var gnEbMinZIndex = 10000;

var gfEbInIframe = false;
var gEbAd = new Object( );
gEbAd.nFlightID = 2424;
var gfEbForceStreaming = 1;
var gstrEbIframeLocation = “IFrameAccount”;
gEbAd.sPublisherPlacementId = “[TPAS]”;

</script>
<script src=“http://ds.serving-sys.com/BurstingScript/ebServing_2424.js”></script>

The variables ‘var’ define in part the location for placing the advertisement in the webpage. The ‘script src’ is a call to a script executed by the ad-serving system 230 when the webpage calls for the script. The script initiates the placement of the advertisements and verification of the advertisements. One embodiment for performing the verification process is discussed in detail below.

The verification process can be performed per advertisement. To this end, the verification process performed by the script can block a placement of the advertisement on the webpage. The blocking of the advertisement placement can be performed if the webpage is targeted by the campaign. For instance, if the webpage contains inappropriate content for certain viewers and/or is catered to a demographic group which is not a target group of the campaign, the webpage may be blocked for those viewers and/or demographic.

According to this embodiment, the determination of whether the webpage should include the advertisement is performed by analyzing the webpage's URL and/or the content of the webpage. As will be discussed in detail below, the ad-serving system 230 is configured to determine a target demographic of the webpage based on its content attribute. The content attribute may be, but is not limited to, a topic discussed in a web page, a layout of a web page, or a font size or color.

According to one embodiment, the verification is performed for per campaign for each advertisement of a campaign served by the ad-serving system 230. In this embodiment, for each served advertisement, the ad-serving system 230, is configured to collect data respective of the served advertisement via execution of the script. Such data will be referred to hereinafter as “ad-serving data,” and includes, but is not limited to, URLs of the web pages in which advertisements are placed, geographic information of users of devices 220 who access the URLs and websites, domain names of the pages' websites, impression counts, time and data that each URL was accessed, a unique identifier of a user device 220 that viewed the advertisement, and so on.

The ad-serving data is typically collected over a predefined period of time (e.g., one month, one day, one hour, and so on). It should be noted that the ad-serving data may be collected for many different campaigns over a large number of websites in which the campaigns run. Therefore, the ad-serving data may include an extensive list of URLs (e.g., millions of records) visited by a large number of users through user devices 220 over a certain period of time. The entire collection of ad-serving data represents target audiences of different campaigns. The ad-serving data can be arranged to provide all users who accessed a particular URL. The users may be identified by a unique identifier such as, for example, a cookie. The ad-serving data can be sorted, for example, by geographical location of users, or by any entity in the collected information.

In an embodiment, URLs in the collected data are URLs visited by the users of the advertisement's campaign to be monitored and verified by a verification system 260. The users of the user devices 220 may be, in part, the target audience of a campaign to be verified.

According to one embodiment, the ad-serving data collected and arranged by the ad-serving system 230 is fed to a profiler 235 included on the ad-serving system 230. According to the disclosed embodiments, the profiler 235 is configured to perform demographic profiling of a set of users based on the URLs that the users visited. The profiling is performed at a user level, i.e., per user of a user device 220-1 through 220-N. It should be noted that the profiling may be performed without having any knowledge about the identity of the users (such as, e.g., a user name). Furthermore, the users are not required to provide any identifying details (e.g., age, name, gender, etc.) about themselves to be profiled.

In an embodiment, the profiler 235 is configured to generate one or more user demographic parameters including, but not limited to, age, gender, hobby(s), income, residence address or location, education, and/or an ethnic group. The user demographic parameters may also be related to social or economic factors such as, e.g., education, residence, or income. Other examples of user demographic parameters may be any information related to skills, occupation, health, trade, race, disabilities, mobility, home ownership, employment status, marital status, number of children, location of origin, or cultural background.

The demographic profiling of users is provided based on one or more heuristics applied to content attributes of visited webpages (referred to by the URLs). Content attributes may be any data, metadata, or other information related to the URL or to the respective page content. Exemplary content attributes may be, but are not limited to, a topic or a set of topics; the nature and purpose of the page (e.g., a blog, forum, news, etc.); an amount of text or other information elements in the page; popularity; language; usage of colors; images or fonts; a writing style; number, location and size of advertisements within the page; pages' domains or sections as indicated by the URLs; “query parameters” (i.e., formats of accepted queries); value of query parameters such as, e.g., a search query (i.e., sample values of queries such as, e.g., a query of the phrase “peanut butter and jelly sandwich”); attributes of the site in which the page is hosted (e.g., number of pages, rate of content change, physical location of hosting, and so on); and attributes of other sites the user is directed to by links within the page. For example, a content attribute may be a topic discussed in a web page, a layout of a web page, or a font size or color appearing on the webpage.

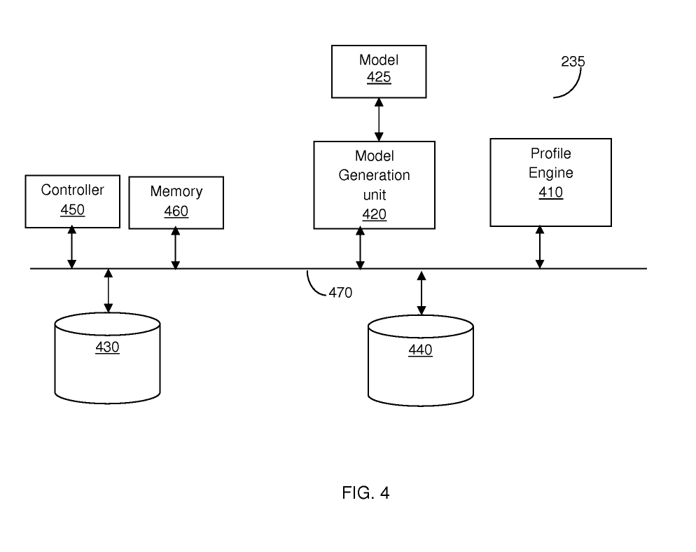

A content attribute may be expressed, represented, or reflected by a set of discrete values, or by a continuous gradual scale. For example, a popularity of a web page may change throughout the day and may be expressed accordingly by a function that may produce different popularity values at different times of the day. In another example, a layout attribute may be expressed, represented, or reflected by a set of values related to more than one aspect, e.g., related to an orientation, an average size of images, and a level of separation between images and text. The profiler 235 is described in greater detail herein below with respect to FIG. 4.

In an embodiment, the ad-serving system 230 is typically run by a third party company that is neither the advertiser nor publisher. Therefore, the ad-serving system 230 delivers, serves, and verifies the advertisements from one central source, so that advertisers and publishers can track the distribution of their online advertisements and have one location for controlling the rotation and distribution of their advertisements across the web.

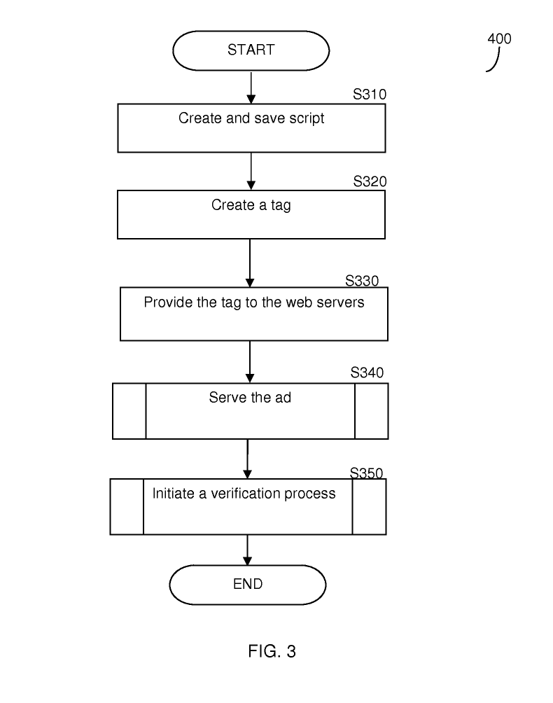

FIG. 3 shows an exemplary and non-limiting flowchart 300 illustrating the operation of the ad-serving system 230 according to one embodiment. In order to allow serving and verification of a campaign, a campaign agency defines a set of serving and verification parameters. The serving parameters include webpages or websites on which to run a campaign, geographical locations in which to run the campaign, duration of a campaign, location of the advertisements in the webpages, and so on. The verification parameters generally define measures to verify that the serving matches the campaign goals. In another embodiment, the verification parameters are derived from a set of criteria used for the targeting of the advertisements. The targeting criteria may be saved in ad-serving system 230. The requirement whether the verification process should be initiated is flagged, for example, by a campaign manager.

At S310, a script is created and saved in the ad-serving system 230. In an embodiment, a script is created based on verification and serving parameters defined by the advertising agency directly through the ad-serving system 230.

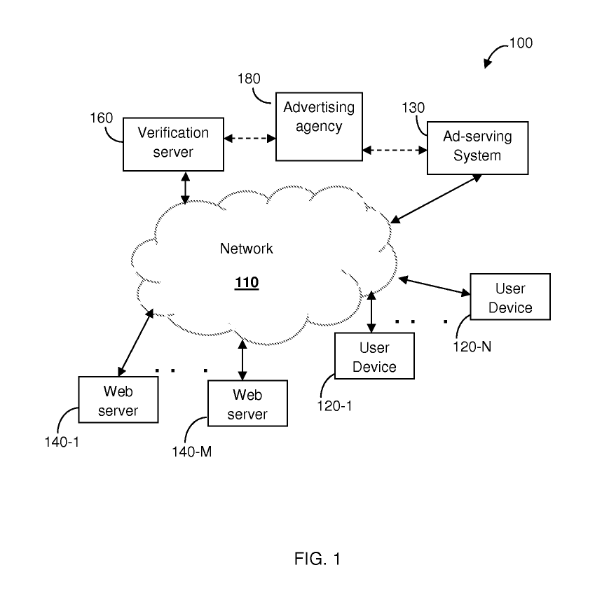

At S320, a tag is created in order to serve and verify the advertisements. An example for such a tag is described in greater detail herein above with respect to FIG. 1. At S330, the tag is provided to web servers (e.g., web servers 140) hosting webpages on which the campaign is designated to run.

At S340, an advertisement is served. In an exemplary embodiment, when a user visits a webpage that includes the tag, the tag causes a web browser (displaying the web-page) to call the ad-serving system 230. In response, the ad-serving system 230 selects an advertisement and places the advertisement in the webpage based on the parameters defined in the tag.

At S350, in response to the call from the web server, a code for execution of verification process is inserted to the served advertisement. Thus, in an embodiment, the service of the advertisement also causes the execution of the verification process. The coded for execution of the verification process may be embedded in the script generated at S310. In an embodiment, the verification process includes analyzing in real-time if the advertisement should be placed in the webpage based on the call to the system 230 that initiated the script creation. In an embodiment, such analysis is achieved by the analyzing the contents and/or URLs of the webpage. If the real-time analysis of the verification process determines that the advertisement serving should be blocked, the advertisement is not served.

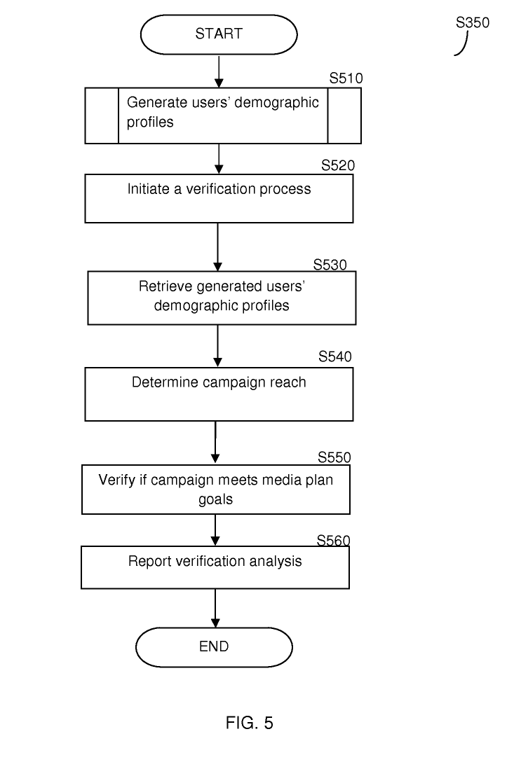

Alternatively or collectivity, according to another embodiment, the verification process is performed offline by the system 230. To this end, the script (provided by the ad-serving system 230) collects ad-serving data related to the advertisement to be served. Such ad-serving data may include, but is not limited to a URL of the web-page that published the advertisement, a campaign ID, advertisements' IDs, time and data that the advertisement URL was visited, a geographical location of a user that visited the URL, view-ability of the advertisement (i.e., where in the web page the advertisement is displayed), and so on. The collected data may also include a unique identifier (e.g., a cookie) of a user who visited a URL. The collected data is sent to the ad-serving system 230 and may be used by the profiler 235 to perform demographic profiling for the users. As further described below, the ad-serving data is utilized to perform an offline demographic verification process. This process is described in greater with respect to FIG. 5.

FIG. 4 shows a non-limiting exemplary block diagram of the profiler 235 according to an embodiment. The profiler 235 includes a profile engine 410, a model generation unit 420 that maintains a model 425, an ad-serving data storage unit 430 utilized to maintain the collected ad-serving data, a users' demographic profiles storage unit 440 utilized to maintain the demographic profiles generated for the users, a controller 450, and a memory 460.

To generate a user demographic profile, the profile engine 410 retrieves all URLs accessed by a particular user from the ad-serving data storage unit 430. Such URLs are fed to the model generation unit 420. In some embodiments, when provided with a URL, the model generation unit 420 is configured to obtain the related content object (e.g., a webpage) referenced, or pointed to, by the URL and to provide the demographic information of the content object (e.g., the web page) and of the user.

Specifically, the model generation unit 420 is configured to analyze the content object (e.g., a web page) and to determine one or more content attributes of the object. For example, a web page may be analyzed, thereby permitting determination of attributes such as fonts' attributes, relevant topics, or layout. The model generation unit 420 is configured to associate attributes of a web page with demographic parameters based on any predefined and configurable scheme, heuristic, or logic. The model generation unit 420 updates the model based on an association of one or more content attributes with one or more demographic parameters or values.

Accordingly, the model 425 may be used to associate a content attribute with a demographic parameter. For example, when provided with a content attribute, the model 425 may provide one or more associated demographic parameters. In an embodiment, the model generation unit 420 first queries the model with content attributes of a web page prior to analyzing such attributes. Therefore, if the model 425 already contains the demographic parameters for a given set of content attributes, such attributes are not processed by the model 425.

It should be noted that the model generation unit 420 is configured to generate, update, or otherwise maintain the model 425 respective of content objects (e.g., web pages) based on information related to anonymous users. For example, an age or gender of a real user and a web page requested by the user may suffice in order to update a model; the actual identity of the user may not be known or recorded.

That is, in one embodiment, the model generation unit 420 is configured to receive a web page (or other content object), analyze the web page to determine its content attributes, associate one or more content attributes with one or more demographic parameters, and update the model 425 based on the association. Various mechanisms, logic, or methods may be used in order to associate content attributes to demographic parameters. In one embodiment, statistical methods or heuristics are used in order to determine an association of content attributes of web pages with demographic parameters. For example, the model generation unit 420 is configured to observe web pages having a specific content attribute (e.g., a specific font style) that are typically or mostly requested by young females, e.g., females between the ages of twelve and fifteen (12-15) years old.

Accordingly, the model 425 may be updated to reflect an association of an attribute that may be a “specific font style” with a demographic parameter or value that may be a “female between the ages of twelve and fifteen”. As another example, an attribute such as a specific writing style may be associated with an occupation (e.g., physicians) and a hobby (e.g., fishing). In yet another example, a specific skill, e.g., related to mathematics, may be associated with a number of content attributes, e.g., with a specific font size and with a specific font color.

Association of one or more demographic attributes with an attribute of a web page may be assigned a probability, factor, weight, or score. For example, an association of the age group 23-27 with a specific page layout may be assigned a probability of 0.87; and an association of a gender (e.g., female) with the same page layout may be assigned a probability of 0.93.

Any method, logic, or scheme may be used to assign a probability to an association of demographic parameters with content attributes. A probability may reflect a matching level of a demographic parameter, or a value with a content attribute. For example, a probability value related to an association of a specific demographic parameter with a specific content attribute may be determined based on the percentage or number of users having the specific demographic parameter who also requested pages that have the same specific attribute. For example, if 90% of the users requesting pages with a specific layout are females, and 56% of the users requesting pages with the same specific layout are older than 50 years of age, then an association of a first demographic parameter (“female”) with the content attribute (the “specific layout”) may be assigned a probability of 0.9 and an association of a second demographic parameter (“older than 50 years of age”) with the same content attribute (the specific layout) may be assigned a probability or score of 0.56.

A set of content attributes and their values may be associated with a set of demographic-parameter distributions. The association rules for performing such that associations may be generated by any method, technique, or by an algorithm. For instance, a set of “machine learning” algorithms may be used to efficiently generate such association rules, with corresponding confidence values. For example, such a method may generate an arbitrary mathematical function that matches the values of certain content attributes such as, for example, font size and page colors, with a distribution of demographic attributes such as, for example, the probability of the user belonging to each of a set of age-groups. Furthermore, such a function may also present the chances of the rule being correct.

Accordingly, two or more different demographic parameters may be associated with a content attribute according to respective first and second probability values. Any number of content attributes may be associated with any number of demographic attributes. For example, a first content attribute of a web page such as, e.g., a topic, may be associated with one or more demographic attributes (possibly according to a respective one or more probabilities), and a second attribute of the same web page (e.g., a layout style) may be associated with a second set of one or more demographic attributes, possibly according to a second set of probabilities.

As a non-limiting example, a web page features content related to the topic “Disney® princesses.” The content attribute associated with this topic is further associated with the demographic attributes “female” and “between 7 and 14 years old” according to the probability 0.95 representing the relative number of users with these demographic attributes demonstrating interest in “Disney® princesses.” Additionally, the web page features pink font. The content attribute associated with this font is further associated with the demographic attribute “female” according to the probability 0.70.

Association of demographic parameters with content attributes, e.g., in the model 425, may be dynamic. For example, by continuously, periodically, or otherwise monitoring requests for web pages and observing related user demographics, the information model 425 may be dynamically updated or maintained, possibly in real-time.

Various heuristics may be used in order to assign scores to associations. For example, a score assigned to an association of a demographic parameter with an attribute of a web page may be determined based on an indication that the association is indeed relevant or adequate. For example, a user input (e.g., in response to a questionnaire) may be used in order to verify an association of demographic parameters with web pages attributes. In other cases, a success of an advertising campaign or a rate of interaction with advertisements may be used as an indication of a correct or adequate association of user demographic information with content attributes.

For example, based on an association of user demographic parameters with a web page attribute, advertisements to be placed in the web page may be selected. A rate or amount of users' interactions with the advertisements may be used as a measure or other indication of the quality or correctness of an association of demographic information with content attributes. A model may be updated based on any input, result, or other data such as, e.g., rate of interactions with advertising content.

Accordingly, based on one or more attributes of a web page, the disclosed embodiments may provide, possibly in real-time, an association of the web page with one or more demographic parameters and may further provide a probability or score (that may be viewed as a match level) for the association. Accordingly, the profile engine 410 is provided with information that may be useful in determining the demographic profiles for the users.

A calculation of a score may be based on any applicable parameters, data, or information. A score or probability assigned to an association of demographic parameters with content attributes may be dynamic. For example, a score of an association of a demographic parameter with an attribute of a web page may be based on information other than the specific attribute. As another example, a demographic parameter (e.g., an age) may be associated with a web page attribute (e.g., a font size) and the association may be given a first score. However, the same association may be given a second, different score if the web page includes specific content, if the web page is requested during a specific time of day, and so on. For instance, a score of 10 (where 10 represents a high likelihood of an association between the demographic and the web page attribute) for an association of an attribute of a web page with a demographic parameter which is “younger than 11 years of age” may be reduced to 6 between 03:00 and 05:00 AM, assuming that users under the age of 11 are not likely to be surfing the internet during such times. Accordingly, scores (and/or probabilities) may be dynamically set.

Assigning scores, probabilities, or match levels to an association of a demographic parameter with a content attribute may be performed at more than one stage or with respect to more than one operation. For example, a mapping of a content attribute to a demographic parameter in a model may be given or assigned a score or probability that may reflect a confidence or match level related to the mapping of the demographic parameter to the content attribute in the model.

The model 425 may contain an association or mapping of content attributes with/to demographic parameters or values. Accordingly, the model 425 may be used to determine or select a demographic parameter or value based on a content attribute.

In response to the URLs provided by the profile engine 410, the model generation unit 420 returns the demographic parameters or information of users who may be interested in the content of the web pages referred to by the URLs. Accordingly, by providing a URL of a web page, demographic parameters or information about each user requesting the web page may be determined.

According to various disclosed embodiments, the profile engine 410 is configured to process all demographic parameters or information returned by the model generation unit 410 for URLs requested by a specific user to determine the user's demographic profile. Various statistical methods can be utilized to determine the user's profile. In an embodiment, the user may be determined by combining all the returned demographic parameters to generate a user profile. In another embodiment, the profile engine 410 considers only demographic parameters having a probability or match level above a predefined threshold. In yet another embodiment, the profile engine 410 considers only demographic parameters associated with the most requested URLs over a predefined period of time (e.g., the top 10 popular websites of the user). The profile engine 410 can also use any combination of these embodiments to determine which demographic parameters to include in the user's demographic profile.

As an example, if the demographic parameters for a first set of URLs visited by the user indicate “female,” another set of demographic parameters for a second set of URLs visited by the user indicate “soccer,” and demographic parameters for a third set of URLs visited by the user indicate the age group of 18-22, the demographic profile for this user would be “female between 18 and 22 years old interested in soccer.”

In an embodiment, a profile confidence score is computed for the generated profile and is indicated by the probability that the generated profile reflects the real demographics of a respective user. The profile confidence score may be computed as a function of a number of processed URLs, and/or the confidence scores of the demographic parameters included in the profile.

The user demographic profile is saved in the storage unit 440 together with the unique identifier (e.g., cookie) of the user. It should be noted that the demographic profile can be generated for users that accessed a webpage with at least one advertisement served by the ad-serving system 230. The storage units 430 and 440 may include non-transitory mediums and may be realized as, for example, a database and associated application, a hard disk drive, a universal serial bus (USB) device, or any other suitable removable and/or fixed storage unit.

The profiler 235 may also include a controller 450 that may be but is not limited to, for example, a central processing unit (CPU), a chip, or any suitable computing or computational device. The profiler 235 may further include a memory 460. The memory 460 may include a plurality of instructions or code executable by the controller 450. The executable code may be an application, a program, a process, a task, or a script programmed to perform the processes described above. The executable code may be executed on or by the controller 450, the profile engine 410, and/or the model generation unit 410. The profiler 235 may also include a network interface to provide communication to the network 210.

The memory 460 may be or may include, but is not limited to, a non-transitory storage medium, a Random Access Memory (RAM), a read only memory (ROM), a Dynamic RAM (DRAM), a Flash memory, a volatile memory, a non-volatile memory, a cache memory, a buffer, a short or long term memory unit, or any other suitable memory units or storage units. The memory 460 may be or may include a plurality of different memory units. The various elements of the profiler 235 are communicatively connected via a bus 470.

In certain disclosed embodiments, the users' demographic profiles are utilized in part by the ad-serving system 230 to perform advertising verification for campaigns served. To this end, the ad-serving system 230 receives ad-serving data related to a specific campaign (hereinafter “campaign data”) to be verified. Such data may include URLs of websites that published the advertisements, a campaign ID, advertisements' IDs, time and data that each advertisement URL was visited, geographical locations of users that visited the URLs, and so on. The campaign data may also include a unique identifier (e.g., a cookie) of a user who visited a URL.

The primary task of the ad-serving system 230 is to determine if the campaign's reach satisfies the targeted audience as defined by the campaign's media plan. For each URL in the campaign data, the ad-serving system 230 is configured to query the profiler 150 to retrieve the demographic profile of each user that visited the URL. The identification of the users that accessed a URL is based on the user unique identifier that was either included in the campaign data or in the ad-serving data stored in the storage unit 230. Unique user identifiers are described further herein above with respect to FIG. 2.

The ad-serving system 230 is configured to process the demographic profiles received from the profiler 235 to determine a demographic reach of the campaign. In one embodiment, the demographic reach is determined by correlating the demographic parameters included in the profiles. In certain embodiments, statistical methods can be utilized to further process the correlation results. In a further embodiment, such processing may include establishing threshold values for inclusion in the demographic reach. For example, if a threshold value of 10% is used and if 2% of the received profiles have demographic parameters of the age group of 10-16, 70% of the received profiles have demographic parameters of the age group of 21-30, and the remaining profiles indicate the age group of 30-35, then the age group of 10-16 will be filtered out from the determined demographic reach because that age group is associated with a probability that is below the threshold.

It should be noted that the campaign's demographic reach may include any combination, aggregation, and/or association of demographic parameters contained in the users' demographic profiles. Examples for such parameters include age, gender, hobby(s), income, residence address or location, education, ethnic group, occupation, health, trade, race, disabilities, mobility, home ownership, employment status, marital status, number of children, cultural background, and so on.

In an embodiment, the campaign's demographic reach that is generated by the ad-serving system 230 provides, for each demographic parameter, a measure (percentage) of the campaign's viewers that can be characterized by the parameter. For example, out of the campaign's viewers, 80% are married couples; 60% are females; and 70% are 45 years and older.

Upon the determination of the campaign demographic reach, the ad-serving system 230 is configured to compare the reach to the campaign's media plan to determine if the campaign's goals have been achieved. In an embodiment, the reach may need to meet a predefined threshold (e.g., 50%, 75%, 90%, and so on) to result in a determination that the campaign's goals have been achieved. As a non-limiting example, if the media plan determines a targeted age group of 13-17, and the campaign's demographic reach delineates that the reach of this age group (13-17) is only 7% compared to a threshold for the campaign plan of 50%, then the campaign's goal has not been achieved. In an embodiment, the comparison of the determined campaign's reach to targets as defined in the campaign's media plan is performed using various statistical methods and/or a preconfigured threshold.

In an embodiment, the verification process is performed off-line, i.e., it is not part of the ad-serving process. The verification process is typically performed when sufficient campaign data has been gathered. It should be appreciated that, because the verification process is based on demographic profiles of real users gathered across many different campaigns, accurate demographic verification is ensured for a specific campaign. The demographic verification includes at least verification of the campaign audience's typecasts and interests.

In certain embodiments the verification process is configured to verify campaign targets or attributes other than the demographic verification. This configuration may include, but is not limited to, inappropriate content verification (e.g., the campaign being advertised in web pages that contain inappropriate and/or questionable content such as violence, adult content, and so on) and content language verifications.

In an embodiment, the inappropriate content language verification is performed by querying the profiler 235 for the content attributes of a web-page referred to by each URL included in the campaign data. As noted above, the profiler 235 using the model generation unit 420 and the model 425 is configured to provide such attributes. The ad-serving system 230 is configured to process and analyze the retrieved content attributes to determine if they match the language(s) and/or are associated with web-pages that publish inappropriate content.

In an embodiment, the ad-serving system 230 is further configured to perform geographical verification, i.e., to determine whether the campaign is being advertised in geographic locations as defined in the campaign's media plan. Such verification is performed by analyzing geographical information included in the gathered campaign data.

In one embodiment, the verification analysis results of different types of verifications may be reported or displayed through a GUI to a user (e.g., a campaign manager and advertising agency, and so on) of the ad-serving system 230.

The ad-serving system 230 can be realized as a computing or computational device including a controller, a CPU (not shown), and a memory (not shown). The memory may include a plurality of instructions or code executable by the CPU. The executable code may be an application, a program, a process, a task, or a script programmed to perform the verification processes as described above. The ad-serving system 230 also includes a network interface to provide communication to the network 210 and a storage unit (not shown) to maintain campaign data and verification analysis results. In an embodiment, the profiler 235 or its functionality is integrated in the ad-serving system 230.

FIG. 5 shows an exemplary and non-limiting flowchart S350 describing a method for performing demographic verification of an advertising campaign according to one embodiment. The demographic verification is performed to check if the campaign indeed has been targeted to one of the specific audiences defined for the campaign. In an embodiment, the demographic verification is performed by the ad-serving system 230.

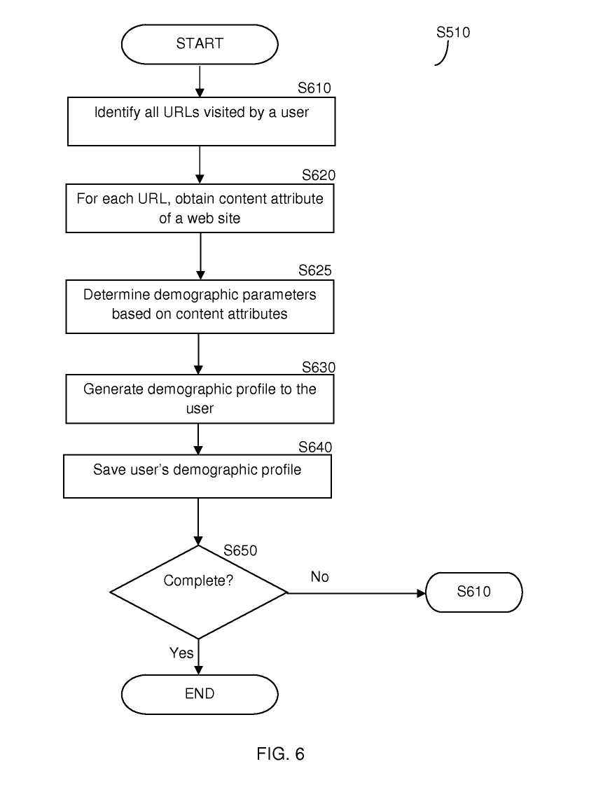

At S510, prior to or in parallel with the verification process, demographic profiles of users are created. The users are people who have viewed advertised content in different web sites. Each user is tracked and identified using a unique identifier (e.g., a cookie). Each user's demographic profile includes one or more demographic parameters. Examples for such parameters are provided above. The process for generating the demographic profiles is discussed in greater detail herein with respect to FIGS. 4 and 6. In an embodiment, S510 profiles may be stored in a database (or other storage means) that maintains the generated users' demographic profiles.

At S520, a verification process is initiated. This may occur when enough campaign data is collected such as, for example, after the campaign is concluded or upon a request of a user of the verification system that such data is ready for processing. As noted above, such data may include URLs of web sites that published the advertisements, a campaign ID, advertisements' IDs, time and date that each advertisement URL was visited, geographical locations of users that visited the URLs, and so on. The campaign data may also include a unique identifier (e.g., a cookie) of a user that visited a URL.

At S530, for each URL in the campaign, one or more users' demographic profiles associated with one or more users who visited the respective webpage are retrieved. As noted above, such webpages include an advertisement served by an ad-serving system (e.g., the ad-serving system 130). It should be noted that the profile may be generated based on the websites previously visited by the user, which may or may not be part of the campaign being verified. S530 would result in verification of the demographic profiles of all users who viewed (or were exposed) to advertisements included in the campaign. It should be noted that, in an embodiment, if the number of retrieved users' demographic profiles is below a certain predefined threshold, the verification process may not be performed.

At S540, the retrieved demographic profiles are analyzed to determine the campaign reach. This analysis includes correlating, aggregating, and/or associating the various demographic parameters in the retrieved parameters. The correlating, aggregating, and/or associating of demographic parameters may be performed using various statistical methods. In an embodiment, the campaign's demographic reach provides, for each demographic parameter, a measure (percentage) of the campaign's viewers that can be characterized by the respective parameter.

At S550, the campaign reach is compared to target audience attributes as defined in the media plan of the campaign. S550 is performed to at least determine whether the campaign was successfully targeted to its intended audience. The comparison may be performed respective of the demographic parameters contained in the determined reach as compared to those related to the target audience attributes. For example, if the target audience attributes include gender, age, and income, only the demographic parameters respective of each of those attributes are used in the comparison. The comparisons may be performed using various statistical methods respective of one or more predefined thresholds.

As an example, the determined reach for the gender, age, and income parameters may be that 60% are females, that 70% are 45 years or older, and that 60% earn a median income. The target audience attributes are middle-age females with a median income. A verification threshold may be set to 50% for each demographic parameter. In this case, the campaign reach achieves the defined targeted audience, since the verification threshold corresponding to each parameter has been met or exceeded. In a counter example, if the audience attributes are young females with no income, the verification thresholds for each attribute are again set to 50%, and the determined reach is the same as in the previous example (i.e., 60% female, 70% that are 45 years or older, and that 60% earning a media income), the campaign fails to achieve its goals as the advertisements are not placed in websites that cater to the demographics of the targeted audience.

At S560, the verification results and analysis (including the determined reached audience) are reported or displayed through, e.g., a GUI.

FIG. 6 shows an exemplary and non-limiting flowchart S510 illustrating the process for generating demographic profiles of users according to one embodiment. At S610, for each user, all URLs in the collected ad-serving data that the user visited are identified. At S620, for each URL visited by the user, at least one content attribute of a web page referred to by the URL and requested by a user is determined. For example, a URL may be extracted from a request received from a user. The URL may be used to generate content attributes such as, for example, site, section, query, and so on. Alternatively, the URL may be used to obtain the web page. The web page may be analyzed and one or more content attributes may be determined. In particular, it should be noted that generating content attributes may not require accessing the web page pointed to by the URL, thereby enabling real-time matching.

At S625, one or more demographic parameters based on at least one content attribute of a web page is determined. The determination may be based on one or more heuristics or methods as discussed in detail above.

At S630, the user demographic profile is generated by correlating, combining, aggregating, and/or associating all demographic parameters determined for the web sites visited by the user. At S640, the user's demographic profile is saved in, e.g., a storage unit. At S650, it is checked if the profiles are generated for all users identified in the ad-serving data and, if so, execution ends; otherwise, execution continues with S610.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for centralized serving and verification of an advertising campaign, comprising:
generating a script based on at least verification parameters for the advertising campaign;
generating a single tag programmed to initiate both serving and verification of an advertisement of the advertising campaign, wherein an instance of the single tag is embedded in each webpage selected to display an advertisement of the advertising campaign;
upon reception of a call from a webpage selected to display an advertisement,
selecting an advertisement to be placed in the webpage; and
inserting a script to the advertisement, wherein the script causing the placement and verification of the advertisement in the web page, wherein the call is triggered by the instance of the single tag.

2. The method of claim 1, wherein the verification is further performed for the advertising campaign, and wherein the verification parameters are set based on targeting criteria defined for the advertising campaign.

3. The method of claim 1, wherein the verification is performed in real time as the advertisement is being placed in the webpage.

4. The method of claim 3, wherein the real time verification includes at least:
determining whether the webpage is suitable for placement of the advertisement; and
blocking the placement of the advertisement if the webpage is determined to be unsuitable.

5. The method of claim 4, wherein the determination is based on at least one: a uniform resource locator of the webpage and content of the webpage.

6. The method of claim 1, wherein the verification of the advertisement includes collecting at least ad-serving data related to the advertisement.

7. The method of claim 6, the ad-serving data includes at least one of: a uniform resource locators (URL), a campaign identification (ID), an advertisement ID, a time of access of the URL, a date of access of the URL, a geographical location of viewer, and a cookie.

8. The method of claim 7, wherein the ad-serving data is utilized to perform demographic verification.

9. The method of claim 7, wherein performing the demographic verification further comprising:
aggregating ad-serving data from a plurality of viewers an advertisement of the advertising campaign;
generating a demographic profile for each user in a group of viewers;
analyzing demographic profiles of viewers of the advertising campaign to determine at least a campaign reach of the advertising campaign, wherein the viewers of the advertising campaign are a subset of the viewers in the group of viewers;
comparing the determined demographic campaign reach to at least one target audience attribute defined in a media plan of the advertising campaign; and
verifying at least a demographic campaign reach based on the comparison.

10. The method of claim 9, further comprising:
storing the demographic profiles in a database; and
reporting at least results of the comparison.

11. The method of claim 9, wherein the demographic profile of a user is generated based on the aggregation of ad-serving.

12. The method of claim 9, wherein the demographic profile includes at least one demographic parameter, wherein the at least one demographic parameter is any one of: age, gender, hobby, income, residence address, country, state, city, education, skills, occupation, health, trade, race, disability, home ownership or lack thereof, employment status, marital status, number of children, and cultural background.

13. The method of claim 12, wherein generating the demographic profile for a viewer further comprising:
identifying all URLs that the viewer visited during the plurality of advertising campaigns;
for each URL visited by the viewer, determining at least one content attribute of a webpage referred to by the URL;
determining at least one demographic parameter based on at least one content attribute of the web page; and
producing the demographic profile of the viewer by processing demographic parameters determined by all the web pages visited by the viewer.

14. The method of claim 9, wherein the demographic profiles are utilized for at least one of: defining and updating a set of targeting criteria for the advertising campaign.

15. A non-transitory computer readable medium having stored thereon instructions for causing one or more processing units to execute the method according to claim 1.

16. A method for centralized serving and verification of an advertising campaign, comprising:
generating a script based on at least verification parameters for the advertising campaign;
generating a single tag programmed to initiate both serving and verification of an advertisement of the advertising campaign, wherein an instance of the single tag is embedded in each webpage selected to display an advertisement of the advertising campaign;
upon reception of a call from a webpage selected to display an advertisement,
selecting an advertisement to be placed in the webpage;
inserting a script to the advertisement, wherein the script causing the placement and verification of the advertisement in the web page, wherein the call is triggered by the instance of the single tag; and
performing a demographic verification for the advertising campaign in response to execution of the script on a plurality of webpages in which the advertisement is placed.

17. The method of claim 16, wherein performing the demographic verification further comprising:
aggregating ad-serving data from a plurality of viewers of the advertisement;
generating a demographic profile for each user in a group of viewers;
analyzing demographic profiles of viewers to determine at least a campaign reach of the advertising campaign, wherein the viewers of the advertising campaign are a subset of the viewers in the group of viewers;
comparing the determined demographic campaign reach to at least one target audience attribute defined in a media plan of the advertising campaign; and
verifying at least a demographic campaign reach based on the comparison.

18. The method of claim 16, wherein the demographic profile of a viewer is generated based on the aggregation of ad-serving.

19. The method of claim 16, wherein the verification parameters are set based on targeting criteria defined for the advertising campaign.

20. The method of claim 17, wherein the demographic profiles are utilized for at least one of: defining and updating a set of targeting criteria for the advertising campaign.

21. A non-transitory computer readable medium having stored thereon instructions for causing one or more processing units to execute the method according to claim 16.

22. A centralized system for performing verification of an advertising campaign, comprising:
a processor; and
a memory coupled to the processor, containing a plurality of instructions that when executed by the processor configure the system to:
generate a script based on at least verification parameters for the advertising campaign;
generate a single tag programmed to initiate both serving and verification of an advertisement of the advertising campaign, wherein an instance of the single tag is embedded in each webpage selected to display an advertisement of the advertising campaign;
upon reception of a call from a webpage selected to display an advertisement,
select an advertisement to be placed in the webpage; and
insert a script to the advertisement, wherein the script causing the placement and verification of the advertisement in the web page, wherein the call is triggered by the instance of the single tag.

23. The system of claim 22, wherein the verification is further performed for the advertising campaign, and wherein the verification parameters are set based on targeting criteria defined for the advertising campaign.

24. The system of claim 22, wherein the verification is performed in real time as the advertisement is being placed in the webpage.

25. The system of claim 23, wherein the system is further configured to:
determine whether the webpage is suitable for placement of the advertisement; and
block the placement of the advertisement if the webpage is determined to be unsuitable.

26. The system of claim 25, wherein the determination is based on at least one: a uniform resource locator of the webpage and content of the webpage.

27. The system of claim 22, wherein the verification of the advertisement includes collecting at least ad-serving data related to the advertisement.

28. The system of claim 27, the ad-serving data includes at least one of: a uniform resource locators (URL), a campaign identification (ID), an advertisement ID, a time of access of the URL, a date of access of the URL, a geographical location of viewer, and a cookie.

29. The system of claim 28, wherein the ad-serving data is utilized to perform demographic verification.

30. The system of claim 28, wherein the system is further configured to:
aggregate ad-serving data from a plurality of viewers an advertisement of the advertising campaign;
generate a demographic profile for each user in a group of viewers;
analyze demographic profiles of viewers of the advertising campaign to determine at least a campaign reach of the advertising campaign, wherein the viewers of the advertising campaign are a subset of the viewers in the group of viewers;
compare the determined demographic campaign reach to at least one target audience attribute defined in a media plan of the advertising campaign; and
verify at least a demographic campaign reach based on the comparison.

31. The system of claim 30, wherein the demographic profile of a user is generated based on the aggregation of ad-serving.

32. The system of claim 30, wherein the demographic profile includes at least one demographic parameter, wherein the at least one demographic parameter is any one of: age, gender, hobby, income, residence address, country, state, city, education, skills, occupation, health, trade, race, disability, home ownership or lack thereof, employment status, marital status, number of children, and cultural background.

33. The system of claim 30, wherein the system is further configured to:
identify all URLs that the viewer visited during the plurality of advertising campaigns;
for each URL visited by the viewer, determine at least one content attribute of a webpage referred to by the URL;
determine at least one demographic parameter based on at least one content attribute of the web page; and
produce the demographic profile of the viewer by processing demographic parameters determined by all the web pages visited by the viewer.

34. The system of claim 30, wherein the demographic profiles are utilized for at least one of: defining and updating a set of targeting criteria for the advertising campaign.
